(19) United States
(12) Patent Application Publication
(10) Pub. No.: US 2026/0238776 A1
(43) Pub. Date: Aug. 13, 2026

(54) TEMPLATE MATCHING PREDICTION METHOD UTILIZING INTRA MODE INFORMATION

(71) Applicants: HYUNDAI MOTOR COMPANY, Seoul (KR); KIA CORPORATION, Seoul (KR); EWHA UNIVERSITY – INDUSTRY COLLABORATION FOUNDATION, Seoul (KR)

(72) Inventors: Je Won Kang, Seoul (KR); Jung Kyung Lee, Seoul (KR); Jung Ah Choi, Seoul (KR); Jin Heo, Yongin-si (KR); Seung Wook Park, Yongin-si (KR)

(73) Assignees: HYUNDAI MOTOR COMPANY, Seoul (KR); KIA CORPORATION, Seoul (KR); EWHA UNIVERSITY – INDUSTRY COLLABORATION FOUNDATION, Seoul (KR)

(21) Appl. No.: 19/469,878

(22) PCT Filed: Jan. 25, 2024
(86) PCT No.: PCT/KR2024/001221

§ 371 Date: Sep. 26, 2025

(30) Foreign Application Priority Data
Apr. 11, 2023 (KR) 10-2023-0047296
Jan. 24, 2024 (KR) 10-2024-0011013

(51) Int. Cl. H04N 19/117; H04N 19/159; H04N 19/176; H04N 19/82

(52) U.S. Cl. CPC H04N 19/117; H04N 19/159; H04N 19/176; H04N 19/82

(57) ABSTRACT

A method and an apparatus are disclosed for video coding utilizing a template matching prediction method based on intra mode information. In the disclosed embodiments, the video decoding device searches for a matching block based on a template matching between templates of reference blocks in a search region and a template of the current block and determines a prediction block of the current block by a searched matching block. The video decoding device decodes a template matching filter flag that indicates whether filtering is to be applied to the prediction block based on the template matching. By checking the template matching filter flag, and when the template matching filter flag is true, the video decoding device determines a shape of a filter by using intra mode information of the current block and applies the filtering to the prediction block by using the filter.

### TECHNICAL FIELD

The present disclosure relates to a video coding method and an apparatus utilizing a template matching prediction method based on intra mode information.

### BACKGROUND

The statements in this section merely provide background information related to the present disclosure and do not necessarily constitute prior art.

Since video data has a large amount of data compared to audio or still image data, the video data requires a lot of hardware resources, including a memory, to store or transmit the video data without processing for compression.

Accordingly, an encoder is generally used to compress and store or transmit video data. A decoder receives the compressed video data, decompresses the received compressed video data, and plays the decompressed video data. Video compression techniques include H.264/Advanced Video Coding (AVC), High Efficiency Video Coding (HEVC), and Versatile Video Coding (VVC), which has improved coding efficiency by about 30% or more compared to HEVC.

However, since the image size, resolution, and frame rate gradually increase, the amount of data to be encoded also increases. Accordingly, a new compression technique providing higher coding efficiency and an improved image enhancement effect than existing compression techniques is required.

In encoding/decoding using template matching-based prediction, a reference block corresponding to a template most similar to the template of the current block is used as a matching block. In template matching-based decoding, the decoder searches for a matching block based on the template matching between the templates of the reference blocks and the template of the current block, and determines the searched matching block as the prediction block of the current block. The decoder uses Sum of Absolute Differences (SAD) or Sum Squared Errors (SSE) to calculate the similarity based on template matching. Since template matching is performed by using multiple reconstructed reference blocks, template matching-based prediction increases the computational complexity of the video decoding process. To reduce the computational complexity, template matching is performed by defining a search region to search for reference blocks. As illustrated in FIGS. 6, R1, R2, R3, and R4 correspond to the search regions for template search.

Meanwhile, filtering may be applied to the intra-Template Matching Prediction (intraTMP). The filter is applied to a reference block, and the filtered reference block is utilized as a prediction block of the current block. For example, the filter is a 6-tap linear filter with five luma taps and one bias term. The filter coefficients are derived for each block by using a regression model that minimizes the mean square error (MSE) between the reference template and the samples in the current template. A template matching filter flag, which indicates whether the linear filter is to be used, is sent from the encoder to the decoder at the CU level. Furthermore, the use of the linear filter is considered as a sub-mode of the intra-template matching prediction. For example, if a template matching flag, which indicates whether the intra-template matching prediction is to be used, is true, the template matching filter flag is signaled. To increase video coding efficiency and enhance video quality, there is a need to find how to utilize intra mode information in the above-described filtering process.

### DISCLOSURE

### Technical Problem

The present disclosure seeks to provide a video coding method and an apparatus that utilize intra mode information in intra-template matching prediction (intraTMP) to adaptively filter reference blocks according to template matching.

### Technical Solution

At least one aspect of the present disclosure provides a method of reconstructing a current block by a video decoding apparatus. The method includes searching, based on a template matching between templates of reference blocks in a search region and a template of the current block, for a matching block, and determining a prediction block of the current block by a searched matching block. The method also includes decoding from a bitstream a template matching filter flag that indicates whether filtering is to be applied to the prediction block based on the template matching. The method also includes checking the template matching filter flag. When the template matching filter flag is true, the method also includes determining a shape of a filter by using intra mode information of the current block and applying the filtering to the prediction block by using the filter.

Another aspect of the present disclosure provides a method of encoding a current block by a video encoding apparatus. The method includes generating a first prediction block of the current block by utilizing a prediction mode that does not use a template matching. The method also includes searching for a matching block based on template matching between templates of reference blocks in a search region and templates of the current block, and determining a second prediction block of the current block with the searched matching block. The method also includes determining a shape of a filter by using intra mode information of the current block. The method also includes generating a filtered second prediction block by applying the filtering to the second prediction block by using the filter.

Yet another aspect of the present disclosure provides a computer-readable recording medium storing a bitstream generated by a video encoding method. The video encoding method includes generating a first prediction block of a current block by utilizing a prediction mode that does not use a template matching. The video encoding method also includes searching for a matching block based on template matching between templates of reference blocks in a search region and templates of the current block, and determining a second prediction block of the current block with the searched matching block. The video encoding method also includes determining a shape of a filter by using intra mode information of the current block. The video encoding method also includes generating a filtered second prediction block by applying the filtering to the second prediction block by using the filter.

### Advantageous Effects

As described above, the present disclosure provides a video coding method and an apparatus that utilize intra mode information in intra-template matching prediction to adaptively filter reference blocks according to template matching. Thus, the video coding method and the apparatus increase objective video coding efficiency and enhance subjective video quality.

### BRIEF DESCRIPTION OF THE DRAWINGS

FIG. 1 is a block diagram of a video encoding apparatus that may implement the techniques of the present disclosure.

FIG. 2 illustrates a method for partitioning a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIG. 6 is a diagram illustrating a search region for template search according to at least one embodiment of the present disclosure.

FIG. 7 is a flowchart of a reconstruction of a current block performed by a video decoding apparatus, according to at least one embodiment of the present disclosure.

FIG. 8 is a diagram illustrating a filter for filtering a prediction block based on template matching, according to at least one embodiment of the present disclosure.

FIG. 9 is a diagram illustrating a filter for filtering a prediction block based on template matching, according to another embodiment of the present disclosure.

FIGS. 10A and 10B are diagrams illustrating subblock partitioning in intra sub-partitions (ISP).

FIG. 11 is a diagram illustrating multiple reference line (MRL) reference samples and reference samples based on template matching, according to at least one embodiment of the present disclosure.

FIG. 12 is a diagram illustrating a gradient filter, according to at least one embodiment of the present disclosure.

FIG. 13 is a flowchart of a method of encoding the current block by a video encoding apparatus, according to at least one embodiment of the present disclosure.

FIG. 14 is a flowchart of a method of reconstructing the current block by a video decoding apparatus, according to at least one embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

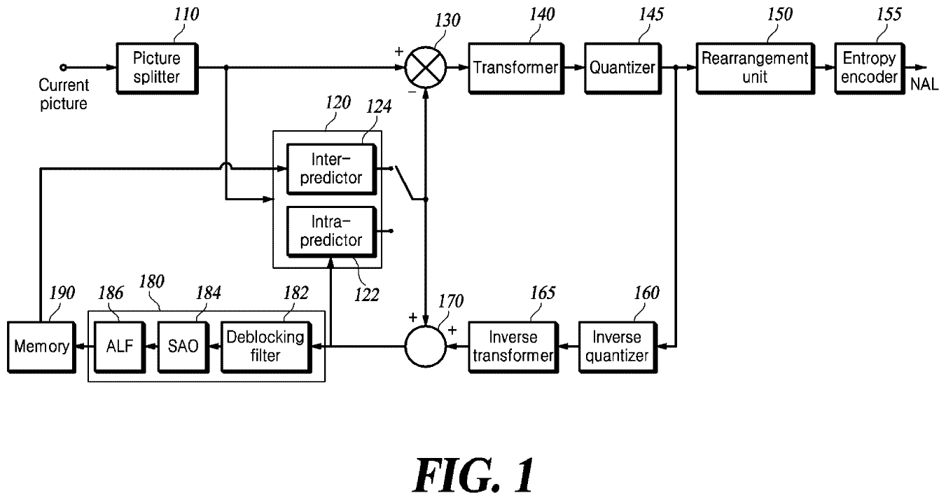

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each coding unit (CU) is encoded as a syntax of the CU, and information commonly applied to the CUs included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU). Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

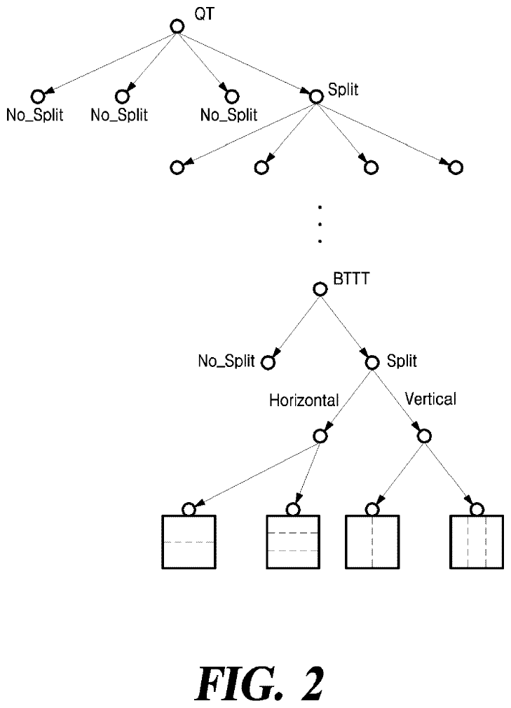

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a ternarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a binarytree ternarytree (BTTT) is added to the tree structures to be referred to as a multiple-type tree (MTT). FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks asymmetrical to each other may be additionally present. The asymmetrical form may include a form in which the block of the corresponding node is split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block.” As the QTBTTT splitting is adopted, a shape of the current block may also be a rectangular shape in addition to a square shape.

The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

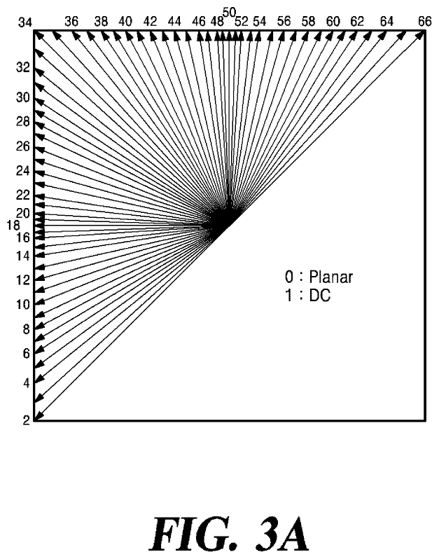

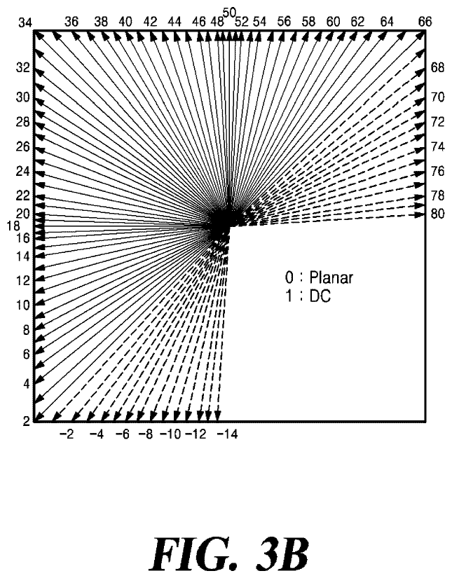

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having a rectangular shape, directional modes (intra prediction modes #67 to #80, #−1 to #−14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than-135 degrees are usable.

The intra predictor 122 may determine an intra prediction to be used for encoding the current block. In some examples, the intra predictor 122 may encode the current block by using multiple intra prediction modes and may also select an appropriate intra prediction mode to be used from tested modes. For example, the intra predictor 122 may calculate rate-distortion values by using a rate-distortion analysis for multiple tested intra prediction modes and may also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current block in the current picture and the prediction block in the reference picture. In general, motion estimation is performed for a luma component, and a motion vector calculated based on the luma component is used for both the luma component and a chroma component. Motion information including information on the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, and the like. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and including information on two motion vectors is delivered to the entropy encoder 155. Here, reference picture list 0 may be constituted by pictures before the current picture in a display order among pre-reconstructed pictures, and reference picture list 1 may be constituted by pictures after the current picture in the display order among the pre-reconstructed pictures. However, although not particularly limited thereto, the pre-reconstructed pictures after the current picture in the display order may be additionally included in reference picture list 0. Inversely, the pre-reconstructed pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

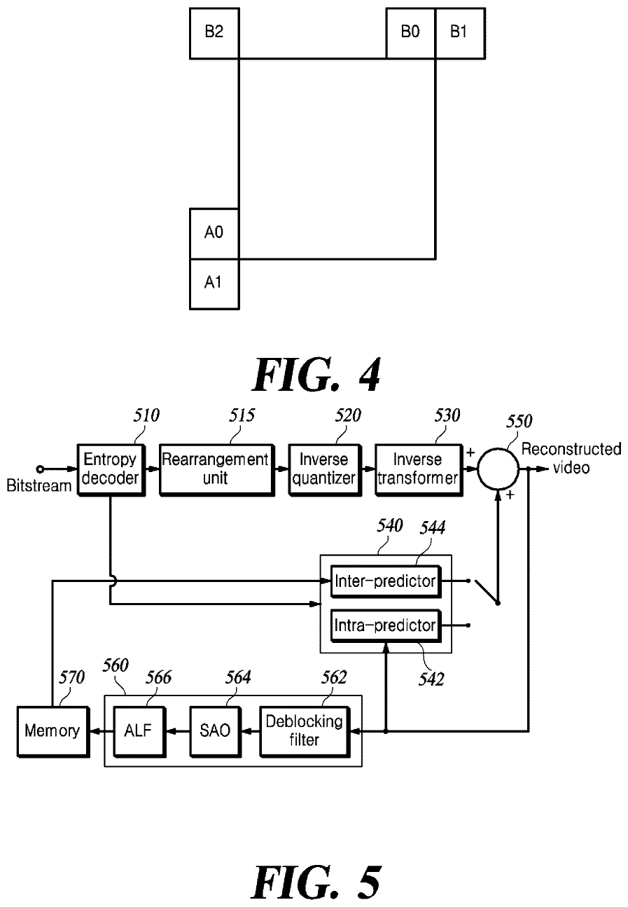

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, and the like) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit or also split the residual block into a plurality of subblocks and may perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and may transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to quantized transform coefficients arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information, such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to reconstruct the residual block.

The adder 170 adds the reconstructed residual block and the prediction block generated by the predictor 120 to reconstruct the current block. Pixels in the reconstructed current block may be used as reference pixels when intra-predicting a next-order block.

The loop filter unit 180 performs filtering for the reconstructed pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the reconstructed blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the reconstructed pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The reconstructed block filtered through the deblocking filter 182, the SAO filter 184, and the ALF 186 is stored in the memory 190. When all blocks in one picture are reconstructed, the reconstructed picture may be used as a reference picture for inter predicting a block within a picture to be encoded afterwards.

The video encoding device may store a bitstream of encoded video data in a non-transitory storage medium or transmit the bitstream to the video decoding device through a communication network.

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for reconstructing the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur, or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT is further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by reconstructing the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to reconstruct the residual signals and fills an area, which is not inversely transformed, with a value of “0” as the residual signals to generate a final residual block for the current block.

Further, when the MTS is applied, the inverse transformer 530 determines the transform function or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510, and predicts the current block by using the motion vector and the reference picture.

The adder 550 reconstructs the current block by adding the residual block output from the inverse transformer 530 and the prediction block output from the inter predictor 544 or the intra predictor 542. Pixels within the reconstructed current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the reconstructed blocks in order to remove the blocking artifact, which occurs due to block unit decoding. The SAO filter 564 and the ALF 566 perform additional filtering for the reconstructed block after the deblocking filtering in order to compensate differences between the reconstructed pixels and original pixels, which occur due to lossy coding. The filter coefficients of the ALF are determined by using information on filter coefficients decoded from the bitstream.

The reconstructed block filtered through the deblocking filter 562, the SAO filter 564, and the ALF 566 is stored in the memory 570. When all blocks in one picture are reconstructed, the reconstructed picture may be used as a reference picture for inter predicting a block within a picture to be encoded afterwards.

The present disclosure in some embodiments relates to encoding and decoding video images as described above. More specifically, the present disclosure provides a video coding method and an apparatus which utilize intra mode information in intra-template matching prediction (intraTMP) to adaptively filter reference blocks according to template matching.

The following embodiments may be performed by the intra predictor 122 in the video encoding device. The following embodiments may also be performed by the intra predictor 542 in the video decoding device.

The video encoding device in encoding the current block may generate signaling information associated with the present embodiments in terms of optimizing rate distortion. The video encoding device may use the entropy encoder 155 to encode the signaling information and transmit the encoded signaling information to the video decoding device. The video decoding device may use the entropy decoder 510 to decode, from the bitstream, the signaling information associated with the decoding of the current block.

In the following description, the term “target block” may be used interchangeably with the current block or coding unit (CU), or may refer to some area of a coding unit.

Further, the value of one flag being true indicates when the flag is set to 1. Additionally, the value of one flag being false indicates when the flag is set to 0.

### I. Template Matching-Based Prediction

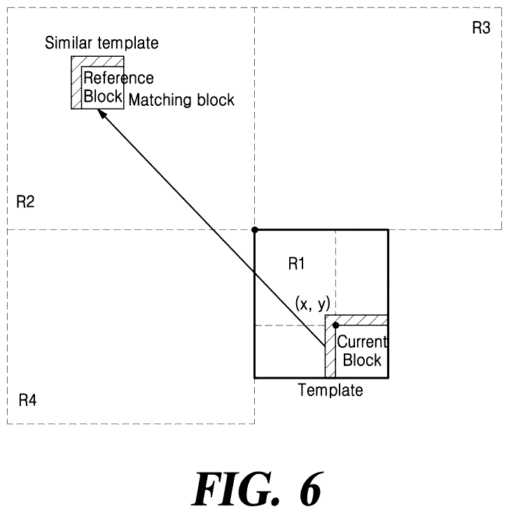

In encoding/decoding using a template matching-based prediction, a reference block corresponding to a template most similar to the template of the current block is used as a matching block. In template matching-based decoding, the video decoding apparatus searches for a matching block based on the template matching between the templates of the reference blocks and the template of the current block, and determines the prediction block of the current block as the searched matching block. The video decoding apparatus uses a measure such as Sum of Absolute Differences (SAD), Sum Squared Errors (SSE), or the like to calculate the similarity based on template matching. Since template matching is performed by using multiple reconstructed reference blocks, template matching-based prediction increases the computational complexity of the video decoding process. To reduce the computational complexity, template matching is performed by defining a search region to search for reference blocks. As illustrated in FIGS. 6, R1, R2, R3, and R4 correspond to the search regions for template search. In the example of FIG. 6, (x,y) denotes the position of the top left sample of the current block.

Hereinafter, a mode for predicting the current block based on template matching is referred to as a template matching-based prediction mode. Additionally, a method of intra predicting the current block by using the template matching-based prediction mode is referred to as template matching-based intra prediction or intra-template matching prediction (intraTMP). Hereafter, template matching-based intra prediction and template matching-based prediction are used interchangeably. Template matching and intra-template matching are used interchangeably.

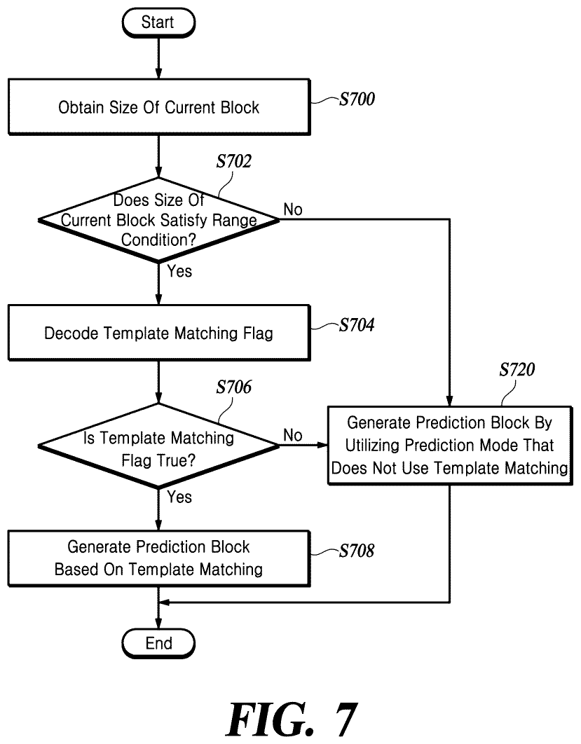

Referring now to FIG. 7, a method of predicting and reconstructing a current block by using a template matching-based prediction mode is described.

FIG. 7 is a flowchart of a reconstruction of a current block performed by the video decoding apparatus, according to at least one embodiment of the present disclosure.

The video decoding apparatus obtains the size of the current block (S700).

The video decoding apparatus determines whether the size of the current block satisfies a range condition (S702). The video decoding apparatus determines whether the size of the current block satisfies a range condition for decoding based on the template matching-based prediction. For example, the range condition refers to a minimum size condition of the current block and/or a maximum size condition of the current block. Depending on whether the range condition is satisfied, the reconstruction process is divided into a reconstruction process that utilizes template matching and a reconstruction process that does not utilize template matching.

If the range condition is satisfied (Yes in S702), the video decoding apparatus decodes a template matching flag (S704). The template matching flag indicates whether intra-template matching is to be used for the current block.

The video decoding apparatus checks the template matching flag (S706).

If the template matching flag is true (Yes in S706), the video decoding apparatus generates a prediction block of the current block based on the template matching (S708).

If the range condition is not satisfied (No in S702) or the template matching flag is false (No in S706), the video decoding apparatus generates the prediction block of the current block by utilizing a prediction mode that does not use template matching (S720). For example, the video decoding apparatus may utilize an intra-prediction mode that does not use template matching or utilize an inter-prediction.

The video decoding apparatus may then decode the residual block and may sum the residual block and the prediction block to generate a reconstructed block of the current block.

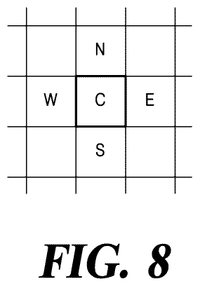

Meanwhile, filtering may be applied to the intra-template matching prediction. The filter is applied to a reference block, and the filtered reference block is utilized as the prediction block of the current block. For example, the filter is a 6-tap linear filter that is cross-shaped with five luma taps and one bias term. As illustrated in FIG. 8, the input to the spatial 5-tap component of the filter is composed of the reference block's center (C) sample, top/north (N) sample, bottom/south(S) sample, left/west (W) sample, and right/east (E) sample at locations corresponding to the samples of the current block. Hereinafter, the 6-tap filter is also referred to as a 5-tap filter without considering the bias term. The output of the filter is calculated as shown in Equation 1.

$$predLumaVal = c 0 C + c 1 N + c 2 S + c 3 E + c 4 W + c 5 B \qquad [ Equation 1 ]$$

In Equation 1, B denotes the bias term.

The filter coefficients shown in Equation 1 are derived for each block by using a regression model that minimizes the mean square error (MSE) between the samples in the template of the reference block and the samples in the template of the current block. MSE minimization includes calculation of an autocorrelation matrix between the reference template and the current template, LDL decomposition of the autocorrelation matrix, and calculation of filter coefficients by back-substitution.

A template matching filter flag, which indicates whether the filter is to be used, is sent from the video encoding apparatus to the video decoding apparatus at the CU level. Furthermore, the use of the linear filter is considered a sub-mode of the intra-template matching prediction. For example, if a template matching flag, which indicates whether the intra-template matching prediction is to be used, is true, the template matching filter flag is signaled.

The following embodiments are described with reference to the video decoding apparatus, but may be implemented in the same or similar manner in the video encoding apparatus.

### II. Embodiments According to the Present Disclosure

As mentioned above, conventional filtering in template matching-based prediction uses a filter with a fixed shape. It disables adaptive filtering from being applied on a block-by-block basis. Hereinafter, adaptive filtering based on different prediction modes of intra prediction in template matching-based prediction is described.

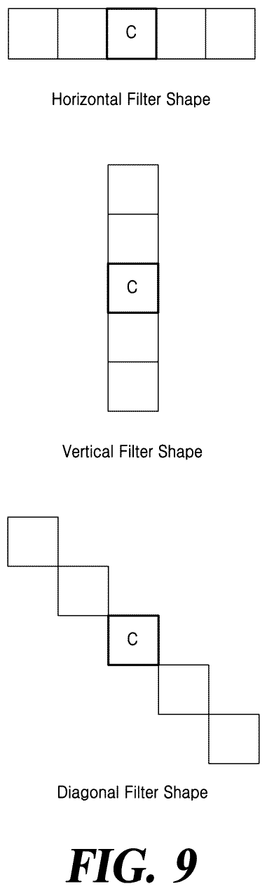

The conventional filtering described above uses a linear filter with five luma taps. The present disclosure utilizes several additional filter shapes, such as horizontal, vertical, diagonal, and the like, as illustrated in FIG. 9. The video decoding apparatus may adaptively select the number of tabs of the filter based on intra mode information. For example, the video decoding apparatus may utilize filters with fewer or more than 5 tabs, such as 3 tabs, 7 tabs, or the like.

When selecting the shape of the filter for filtering the prediction block based on template matching, the video decoding apparatus uses the same method as the method of obtaining the reference samples in the angular intra-prediction mode. In the VVC (Versatile Video Coding), intra-prediction modes are categorized into three groups (e.g., groups A, B, and C), and reference samples of angular intra-prediction modes are constructed by using a [1,2,1] smoothing filter, a gaussian interpolation filter, and a cubic interpolation filter for each group. Group A includes horizontal prediction modes and vertical prediction modes, group B includes diagonal modes that are multiples of 45 degrees, and group C includes other angular modes. In one example, for the prediction mode included in group A, the video decoding apparatus selects a horizontal or vertical filter shape illustrated in FIG. 9 to perform filtering of the prediction block based on template matching. For the prediction mode included in group B, the video decoding apparatus utilizes the diagonal filter illustrated in FIG. 9. For the prediction modes included in group C, the video decoding apparatus uses a conventional cross-shaped 5-tap filter, as illustrated in FIG. 8. Alternatively, the video decoding apparatus may perform no filtering for blocks having a prediction mode included in group C.

On the other hand, classifying the intra-prediction modes into three groups is only an example. For example, the intra-prediction modes may be classified into N groups according to the characteristics of the intra-prediction modes, and for each group, a filter shape may be specified for filtering the prediction blocks according to template matching. Here, N may be any positive integer, and is not limited to any particular value in the present disclosure.

The video decoding apparatus uses as a basis a prediction mode group that includes an intra-prediction mode of the current block among N (a positive integer) prediction mode groups, for determining a filter shape for filtering the prediction block based on the template matching. For application of the present disclosure, the video encoding apparatus may signal the intra-prediction mode of the current block to the video decoding apparatus.

Further, the video decoding apparatus may derive a group of angular intra-prediction modes and determine a filter shape for the prediction block based on the template matching, according to one of the following methods.

In one example, the video decoding apparatus utilizes the above-described group classification of intra-prediction modes in the VVC for the prediction block based on template matching. Namely, the video decoding apparatus determines the filter shape based on a prediction mode group that includes the intra-prediction mode of the prediction block. For example, the video decoding apparatus utilizes the intra-prediction mode of a block containing the prediction block. Alternatively, the video decoding apparatus may utilize the intra-prediction mode of a large block having the largest width and overlapping with the prediction block.

As another example, the video decoding apparatus utilizes the intra-prediction mode of a block including a 4×4 block on the top left side of the prediction block based on template matching. Namely, the video decoding apparatus derives a group of angular intra-prediction modes and determines a filter shape according to the intra-prediction mode of the above-described block.

As yet another example, the video decoding apparatus utilizes the intra-prediction mode of a block that includes a central 4×4 block of the prediction block based on template matching. Namely, the video decoding apparatus derives a group of angular intra-prediction modes and determines a filter shape according to the intra-prediction mode of the above-described block.

Generally, intra-prediction uses the most probable mode (MPM) based on the fact that the current block and neighboring blocks are often similar to each other. In VVC, 6 MPMs are supported, and in the enhanced compression model (ECM), 6 MPMs are used as primary MPMs and 16 MPMs are used as secondary MPMs. In embodiments according to the present disclosure, the video decoding apparatus uses as a basis two or more intra-prediction modes from the above-described list of MPMs for selecting filters for filtering the prediction block based on template matching, and combines output values based on application of the selected filters. An example may use two angular intra-prediction modes with the smallest index and the second smallest index in the MPM/primary MPM/secondary MPM. For example, if the two directions are horizontal and vertical, respectively, the video decoding apparatus selects a horizontal filter shape and a vertical filter shape, and performs filtering of the prediction block based on template matching by using the two filter shapes. Finally, the video decoding apparatus generates the final prediction block by weight summing the values of the outputted blocks by using the preset weights. If the weighted sum is generated by using variable weights rather than the preset weights, the variable weights are signaled from the video encoding apparatus to the video decoding apparatus.

As yet another example, one angular intra-prediction mode with the smallest index may be selected in the MPM/primary MPM/secondary MPM. The video decoding apparatus determines, as described above, which of the groups A, B, and C the selected prediction mode belongs to, and selects a filter shape based on the determined group.

As yet another example, when using two filter types or more, the video encoding apparatus signals the indices of the filters to the video decoding apparatus. Alternatively, the video encoding apparatus signals to the video decoding apparatus indices indicative of two prediction modes in the MPM list as described above. The video decoding apparatus determines, as described above, which of the groups A, B, and C the signaled prediction mode is included in, and selects a filter shape based on the determined group.

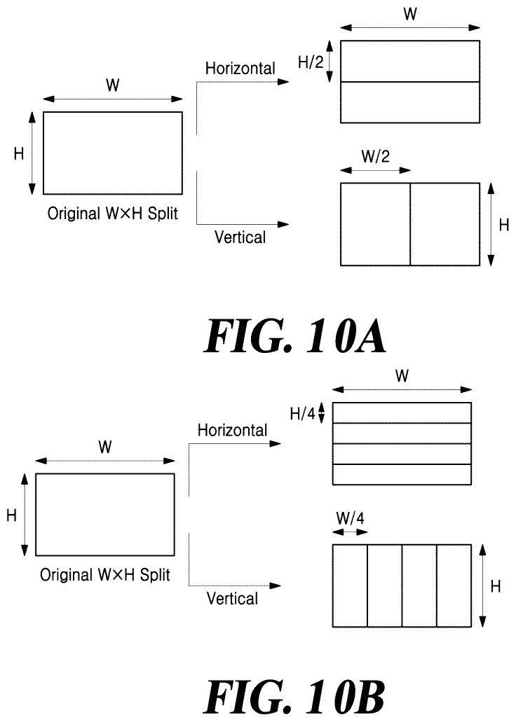

The intra sub-partitions (ISP) technique is dependent on the size of the block to partition the block into two or four sub-partitions in a vertical or horizontal direction, and applies the same intra-prediction mode to each sub-partition to perform the prediction. As illustrated in FIG. 10A, if the size of the block is 4×8 or 8×4, the block is partitioned into two subblocks. Additionally, if the size of the block is larger than 4×8 or 8×4, the block is partitioned into four subblocks. At this time, depending on whether the partitioning direction is horizontal or vertical, the video decoding apparatus selects a filter shape for filtering the prediction block based on the template matching. For example, in the examples of FIGS. 10A and 10B, at the horizontal partitioning, the video decoding apparatus selects a horizontal filter shape to perform filtering of the prediction block based on the template matching. For application of the present disclosure, the video encoding apparatus may signal information related to the ISP to the video decoding apparatus.

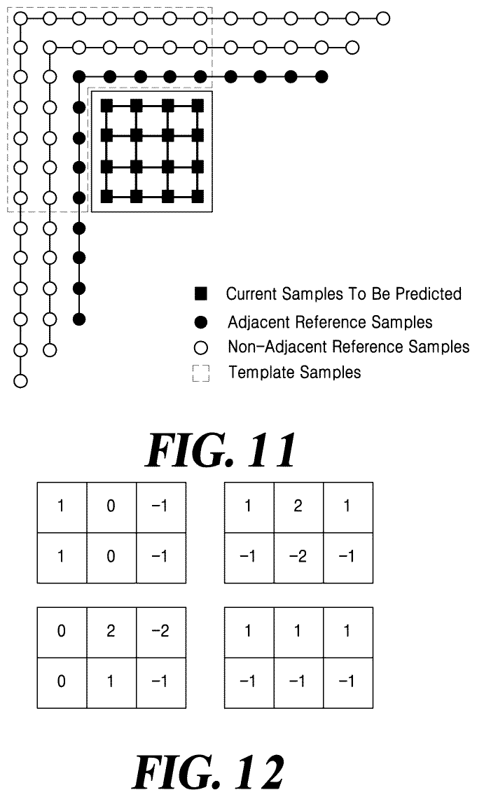

The multiple reference line (MRL) technique is used when performing intra prediction to utilize a larger number of reference lines (1 line, 3 lines, 5 lines, 7 lines, 12 lines, or the like). The conventional method, when calculating the coefficients of the filter, uses samples from both the template of the current block and the template of the reference block. In this embodiment, the video decoding apparatus selects the samples in the template according to the reference line in the MRL prediction, and then uses the selected samples to calculate the filter coefficients. The video encoding apparatus separately signals the index of the selected reference line to transfer the reference line used to calculate the filter coefficients. The video decoding apparatus decodes the index of the reference line and then calculates the filter coefficients by using the reference line indicated by the index. The example of FIG. 11 shows, as dotted boxes, the samples used to calculate the filter coefficients according to a conventional method. In the present embodiment of the disclosure, the video decoding apparatus may calculate the coefficients of the filter for filtering the prediction block by using the reference lines within the dotted box or regardless of the dotted box, but using samples of some/all of the reference lines used by the MRL.

In the present embodiment of the disclosure, the video decoding apparatus uses a gradient filter, such as a Sobel filter, to identify a gradient characteristic of the current block, and performs filtering of the prediction block based on the template matching according to the identified gradient characteristic. By calculating the gradient value G(i, j) at the position (i, j) of the sample of the template of the current block, the video decoding apparatus calculates the sum of the gradients. Based on the sum of the gradients according to the horizontal gradient value or the vertical gradient value, i.e., the total amount of variation, the video decoding apparatus identifies the gradient characteristics of the current block. Based on the identified gradient characteristics of the current block, the video decoding apparatus selects the filter shape for filtering the prediction block based on the template matching.

The video decoding apparatus calculates a sum of a horizontal gradient value Gₕ and a vertical gradient value Gᵥ, and selects a filter shape that includes a component with a larger amount of variation. In one example, where ΣGₕ(i,j)<ΣGᵥ(i,j), the vertical filter shape illustrated in FIG. 9 may be selected. FIG. 12 illustrates an example gradient filter.

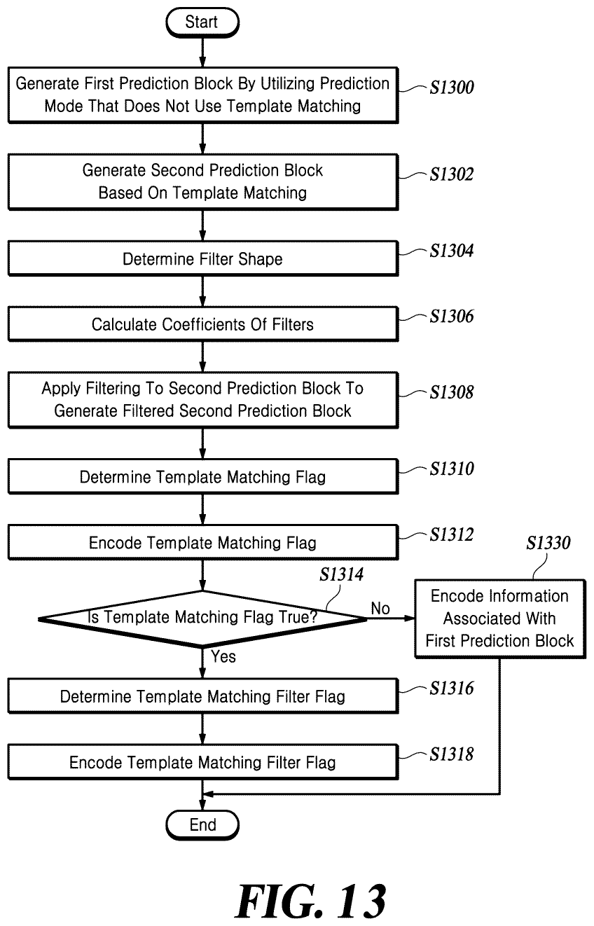

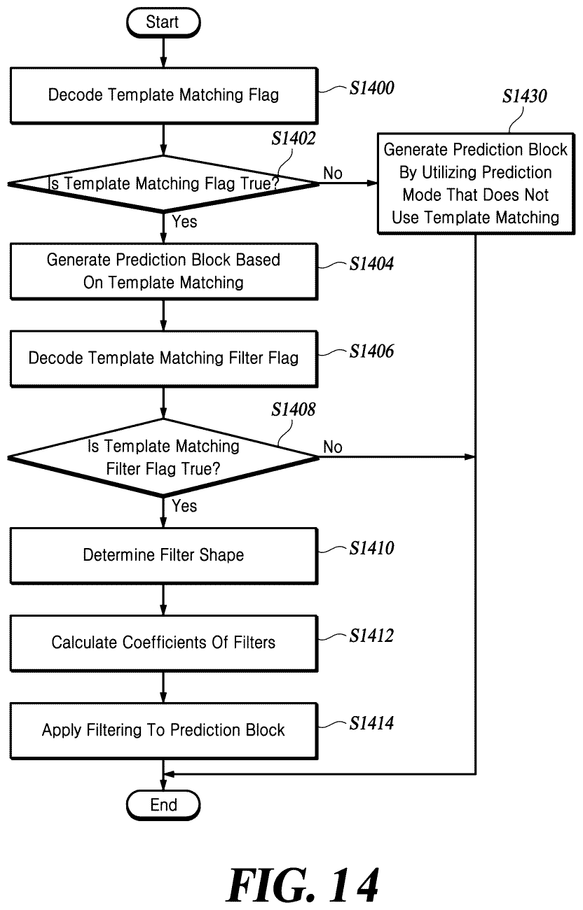

Referring now to FIGS. 13 and 14, methods are described for adaptively applying a filter to template matching by utilizing intra mode information.

FIG. 13 is a flowchart of a method of encoding the current block by the video encoding apparatus, according to at least one embodiment of the present disclosure.

The video encoding apparatus generates a first prediction block of the current block by utilizing a prediction mode that does not use template matching (S1300). For example, the video encoding apparatus may utilize an intra-prediction mode that does not use template matching or an inter-prediction mode.

The video encoding apparatus obtains the size of the current block and determines whether the size of the current block satisfies a range condition for the current block's size to be encoded based on the template matching-based prediction. The range condition is, for example, a block's minimum-size condition and/or a block's maximum-size condition. When the range condition is satisfied, the video encoding apparatus performs the template matching-based prediction.

The video encoding apparatus generates a second prediction block of the current block based on the template matching (S1302).

The video encoding apparatus predicts the current block by using template matching according to a preset order (e.g., z-scan order). The video encoding apparatus searches for a matching block based on the template matching between the templates of the reference blocks in the search region and the template of the current block, and determines the searched matching block to be a second prediction block of the current block.

The video encoding apparatus determines the shape of the filter by using the intra mode information of the current block (S1304).

If two or more filter shapes are used for filtering the prediction block based on the template matching, the video encoding apparatus further determines the indices of the filters to be used. The video encoding apparatus encodes the indices of the filters.

The video encoding apparatus calculates the coefficients of the filters (S1306).

The video encoding apparatus derives the filter coefficients by using a regression model that minimizes the MSE between the samples in the template of the matching block and the samples in the template of the current block.

The video encoding apparatus applies filtering to the second prediction block based on the filter to generate a filtered second prediction block (S1308).

Further, if two filters are determined, the video encoding apparatus performs filtering of the second prediction block by using the two filters to generate two filtered second prediction blocks. The video encoding apparatus then weight-sums the values of the outputted second prediction blocks by using the preset weights to generate a final filtered second prediction block.

The video encoding apparatus determines a template matching flag based on the first prediction block, the second prediction block, and the filtered second prediction block (S1310). Here, the template matching flag indicates whether template matching is enabled for the current block.

In terms of rate distortion optimization, the video encoding apparatus determines the template matching flag. For example, if the first prediction block is optimal, the template matching flag is determined to be false. On the other hand, if the second prediction block or the filtered second prediction block is optimal, the template matching flag is determined to be true.

The video encoding apparatus encodes the template matching flag (S1312).

The video encoding apparatus checks the template matching flag (S1314).

If the template matching flag is true (Yes in S1314), the video encoding apparatus performs the following steps.

The video encoding apparatus determines a template matching filter flag based on the second prediction block and the filtered second prediction block (S1316). Here, the template matching filter flag indicates whether filtering is to be applied to the prediction block based on the template matching.

In terms of rate distortion optimization, the video encoding apparatus determines the template matching filter flag. For example, if the second prediction block is optimal, the template matching filter flag is determined to be false. On the other hand, if the filtered second prediction block is optimal, the template matching filter flag is determined to be true.

The video encoding apparatus encodes the template matching filter flag (S1318).

If the template matching flag is false (No in S1318), the video encoding apparatus encodes the information associated with the first prediction block (S1330).

The video encoding apparatus then subtracts the prediction block based on the template matching flag and the template matching filter flag from the current block to generate a residual block. The video encoding apparatus applies a transform/quantization to the residual block to generate quantized transform coefficients, and then encodes the quantized transform coefficients.

FIG. 14 is a flowchart of a method of reconstructing the current block by the video decoding apparatus, according to at least one embodiment of the present disclosure.

The video decoding apparatus obtains the size of the current block and determines whether the size of the current block satisfies a range condition (e.g., a block's minimum-size condition and/or a block's maximum-size condition) for the size of the current block to be encoded according to a template matching-based prediction.

If the range condition is satisfied, the video decoding apparatus decodes a template matching flag (S1400). The template matching flag indicates whether intra-template matching is to be used for the current block.

The video decoding apparatus checks the template matching flag (S1402).

If the template matching flag is true (Yes in S1402), the video decoding apparatus takes the following steps.

The video decoding apparatus generates a prediction block of the current block based on the template matching (S1404).

The video decoding apparatus predicts the current block by using template matching according to a preset order (e.g., z-scan order). The video decoding apparatus searches for a matching block based on the template matching between the templates of the reference blocks in the search region and the template of the current block, and determines the searched matching block to be the prediction block of the current block.

The video decoding apparatus decodes a template matching filter flag (S1406). Here, the template matching filter flag indicates whether filtering is to be applied to the prediction block based on the template matching.

The video decoding apparatus checks the template matching filter flag (S1408).

If the template matching filter flag is true (Yes in S1408), the video decoding apparatus takes the following steps.

The video decoding apparatus determines a filter shape by using the intra mode information of the current block (S1410).

If two or more filter shapes are used for filtering the prediction block based on template matching, the video decoding apparatus further decodes the indices of the filters used.

The video decoding apparatus calculates the coefficients of the filters (S1412).

The video decoding apparatus derives the filter coefficients by using a regression model that minimizes the MSE between the samples in the template of the matching block and the samples in the template of the current block.

The video decoding apparatus applies filtering to the prediction block by using the determined filter (S1414). The video decoding apparatus applies filtering to the prediction block based on the template matching to generate a filtered prediction block.

Further, if two filters are determined, the video decoding apparatus performs filtering of the prediction block by using the two filters to generate two filtered prediction blocks. Then, the video decoding apparatus generates a final prediction block by weight summing the values of the outputted prediction blocks by using the preset weights.

If the template matching filter flag is false (No in S1408), the video decoding apparatus does not perform filtering of the prediction block based on the template matching.

If the range condition is not satisfied or the template matching flag is false (No in S1402), the video decoding apparatus generates the prediction block of the current block by utilizing a prediction mode that does not use template matching (S1430). For example, the video decoding apparatus may utilize an intra-prediction mode that does not use template matching or an inter-prediction mode.

The video decoding apparatus then decodes the quantized transform coefficients and applies an inverse quantization/inverse transform to the quantized transform coefficients to generate a residual block. The video decoding apparatus may sum the residual block and the prediction block based on the template matching flag and the template matching filter flag to generate a reconstructed block of the current block.

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

### REFERENCE NUMERALS

122: intra predictor
155: entropy encoder
510: entropy decoder
542: intra predictor

### CROSS-REFERENCE TO RELATED APPLICATIONS

This application claims priority to and the benefit of Korean Patent Application No. 10-2023-0047296 filed on Apr. 11, 2023, and Korean Patent Application No. 10-2024-0011013, filed on Jan. 24, 2024, the entire contents of each of which are incorporated herein by reference.

What is claimed is:

1. A method of reconstructing a current block by a video decoding apparatus, the method comprising:
searching, based on a template matching between templates of reference blocks in a search region and a template of the current block, for a matching block, and determining a prediction block of the current block by a searched matching block;
decoding from a bitstream a template matching filter flag that indicates whether filtering is to be applied to the prediction block based on the template matching; and
checking the template matching filter flag,
wherein the method further comprises, when the template matching filter flag is true:
determining a shape of a filter by using intra mode information of the current block; and
applying the filtering to the prediction block by using the filter.

2. The method of claim 1, further comprising:
decoding a template matching flag that indicates whether the template matching is to be used for the current block;
checking the template matching flag; and
when the template matching flag is true, proceeding with determining the prediction block of the current block.

3. The method of claim 1, wherein the shape of the filter comprises:
a cross-shaped filter, a horizontal filter, a vertical filter, or a diagonal filter.

4. The method of claim 1, wherein determining the shape of the filter comprises:
determining the shape of the filter according to a prediction mode group including an intra-prediction mode of the current block among N prediction mode groups, N being a positive integer.

5. The method of claim 4, wherein determining the shape of the filter comprises, when the prediction mode group includes a horizontal prediction mode and a vertical prediction mode:
determining the shape of the filter to be a horizontal filter or a vertical filter.

6. The method of claim 4, wherein determining the shape of the filter comprises, when the prediction mode group includes a diagonal prediction mode:
determining the shape of the filter to be a diagonal filter.

7. The method of claim 4, wherein determining the shape of the filter comprises, when the prediction mode group includes an angular mode excluding a horizontal prediction mode, a vertical prediction mode, and a diagonal prediction mode:
determining the shape of the filter to be a cross-shaped filter.

8. The method of claim 4, wherein determining the shape of the filter comprises:
checking an intra-prediction mode of a block containing a block of a preset size present at a top left side of the prediction block; and
determining the shape of the filter according to the prediction mode group including the intra-prediction mode.

9. The method of claim 4, wherein determining the shape of the filter comprises:
checking an intra-prediction mode of a block containing a block of a preset size present at a center of the prediction block; and
determining the shape of the filter according to the prediction mode group including the intra-prediction mode.

10. The method of claim 4, wherein determining the shape of the filter comprises:
generating a list of most probable modes (MPMs) of the current block;
selecting, from the list of MPMs, an angular prediction mode with a smallest index; and
determining the shape of the filter according to a prediction mode group that includes the angular prediction mode.

11. The method of claim 4, wherein determining the shape of the filter comprises:
generating a list of MPMs of the current block;
selecting, from the list of MPMs, two angular prediction modes having a smallest index and a second smallest index; and
determining the shape of the filter according to a prediction mode group that includes each of the angular prediction modes.

12. The method of claim 11, further comprising:
generating two filtered prediction blocks by applying filters corresponding to the two angular prediction modes to the prediction block; and
generating a final prediction block by weight summing the two filtered prediction blocks.

13. The method of claim 1, further comprising:
calculating coefficients of the filter by using a regression model that minimizes a mean square error (MSE) between samples in a template of the matching block and samples in the template of the current block.

14. The method of claim 13, wherein calculating the coefficients of the filter comprises:
decoding indices of reference lines from the bitstream, the indices indicating reference lines used for calculating the coefficients of the filter; and
calculating the coefficients of the filter by using samples within the reference lines indicated by the indices within the template of the matching block and the template of the current block.

15. The method of claim 1, wherein determining the shape of the filter comprises:
determining a gradient characteristic of the current block by using a gradient filter; and
determining the shape of the filter based on the gradient characteristic.

16. A method of encoding a current block by a video encoding apparatus, the method comprising:
generating a first prediction block of the current block by utilizing a prediction mode that does not use a template matching;
searching for a matching block based on template matching between templates of reference blocks in a search region and templates of the current block, and determining a second prediction block of the current block with the searched matching block;
determining a shape of a filter by using intra mode information of the current block; and
generating a filtered second prediction block by applying the filtering to the second prediction block by using the filter.

17. The method of claim 16, further comprising:
determining, based on the first prediction block, the second prediction block, and the filtered second prediction block, a template matching flag that indicates whether the template matching is to be used for the current block;
encoding the template matching flag; and
checking the template matching flag.

18. The method of claim 17, further comprising, when the template matching filter flag is true:
determining, based on the second prediction block and the filtered second prediction block, a template matching filter flag that indicates whether filtering is to be applied to the prediction block based on the template matching; and
encoding the template matching filter flag.

19. A computer-readable recording medium storing a bitstream generated by a video encoding method, wherein the video encoding method comprises:
generating a first prediction block of a current block by utilizing a prediction mode that does not use a template matching;
searching for a matching block based on template matching between templates of reference blocks in a search region and templates of the current block, and determining a second prediction block of the current block with the searched matching block;
determining a shape of a filter by using intra mode information of the current block; and
generating a filtered second prediction block by applying the filtering to the second prediction block by using the filter.
